(19) United States
(12) Patent Application Publication
(10) Pub. No.: US 2008/0125528 A1
(43) Pub. Date: May 29, 2008

(54) Liquid Silicone Rubber

(75) Inventors: Peter Jerschow, Burghausen (DE); Erich Schaffer, Thaur (AT)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 11/946,065

(22) Filed: Nov. 28, 2007

(30) Foreign Application Priority Data
Nov. 29, 2006 (DE) 10 2006 056 378.6

(51) Int. Cl. C08K 5/56; C08K 5/54

(52) U.S. Cl. 524/262; 524/588

(57) ABSTRACT

Organopolysiloxane moldings are prepared from
(A) compounds which have radicals having aliphatic carbon-carbon multiple bonds,
(B) organopolysiloxanes having Si-bonded hydrogen atoms, and
(D) a hydrosilylation catalyst,
by a process involving
first preparing an admixture of 100 parts by weight of (A) and (B) or (A) and (D), and then feeding, into the mixer of a plastics-processing machine, either from 0.3 to 5 parts by weight of (D), based on the catalyst formulation, into the mixture of (A) and (B), or from 0.3 to 5 parts by weight of (B) into the mixture of (A) and (D).

### BACKGROUND OF THE INVENTION

1. Field of the Invention

The invention relates to a process for the preparation of curable organopolysiloxane compositions.

2. Background Art

Previously, LSR (Liquid Silicone Rubber) or LIM (liquid injection molding) compositions have typically involved 2 components (A and B) being pumped in a ratio of 1:1 to 9:1 into a static mixer. This mixture can then be further processed by an injection-molding machine or by other machines to produce moldings, extrudates, or coatings.

The two components are composed minimally of polydimethylsiloxanes having vinyl groups. Other substituents than methyl groups are also conceivable. The viscosities generally range from 0.65 to 10,000,000 mPa·s). In order to achieve the final properties, fillers and additives are generally added.

Fillers can be active (reinforcing) or inert, dependent on the requirements placed upon the LSR. Examples of active fillers are hydrophobic or hydrophilic highly dispersed silica, hydrophobic or hydrophilic precipitated silica, hydrophobic or hydrophilic aluminum oxide, etc. Examples of inert fillers are powdered quartz, talc, wollastonite, etc.

A platinum catalyst such as hexachloroplatinic acid or a vinylsiloxane complex thereof is generally added to the A component. An Si—H compound which contains at least 2 or 3 silicon-bonded H atoms per molecule is added to the B component. An inhibitor is added either into the A component or into the B component to regulate the crosslinking rate.

One or both components can also contain adhesion promoters or oils incompatible with the matrix, for example phenylsilicone oil, or heat stabilizers (metal oxides, metal octoates, carbon blacks).

The time required by these A components and B components for crosslinking during production of, for example, a pacifier, using a shot weight of 5 g, in a mixture of from 1:1 to 9:1, is usually no more than 25 s at a vulcanization temperature of 180° C. The A-B mixture remains liquid for a period of at least 3 days at room temperature, thus permitting a fresh startup to be made after any production stoppage.

### SUMMARY OF THE INVENTION

An object of the invention is to provide a flexible method for producing molded silicone articles, and to reduce the molding time necessary for their preparation. These and other objects have been achieved by supplying the largest portion of the curable components as a base mixture, and adding the remaining necessary ingredients just prior to molding. A surprising reduction of curing time is thus achieved, with the ability to tailor article physical properties as well.

### BRIEF DESCRIPTION OF THE DRAWINGS

FIG. 1 shows prior-art LSR processing, wherein the 2 components (component A) and (component B) are pumped in a mixing ratio of 1:1 to 9:1 into a static or dynamic mixer (3). Color can be fed by way of an additive line (2). The resultant composition can then be further processed in the mold (4) and (5); and

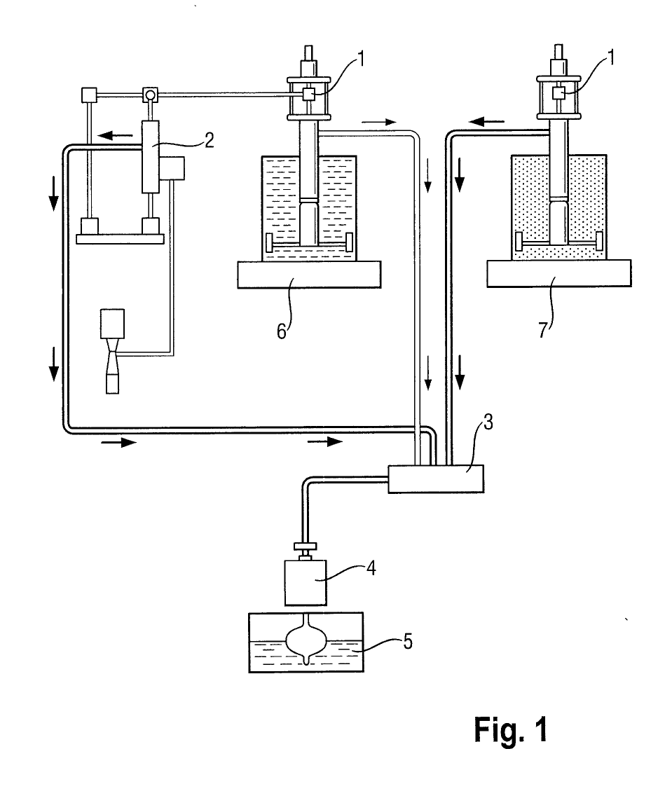

FIG. 2 illustrates the method of the present invention.

### DETAILED DESCRIPTION OF THE PREFERRED EMBODIMENT(S)

The present invention provides a process for the preparation of curable organopolysiloxane compositions, comprising

### (A) compounds which have radicals having aliphatic carbon-carbon multiple bonds,

### (B) organopolysiloxanes having Si-bonded hydrogen atoms, and

### (D) catalyst,

which comprises first admixing an amount of 100 parts by weight of (A) and (B) or (A) and (D) preferably to a container, and then feeding the admixture into the mixer of a plastics-processing machine, preferably an injection-molding machine, a doctor device, extruder, calender system, etc., with preference an injection-molding machine, preferably by way of a pump unit, either with preference from 0.3 to 5 parts by weight, more preferably from 0.3 to 4 parts by weight, yet more preferably from 0.3 to 3 parts by weight, still more preferably from 0.3 to 2 parts by weight, particularly preferably from 0.3 to 1 part by weight, and most preferably 1 part by weight, of (D), based on the catalyst formulation being mixed, into (A) and (B), or with preference from 0.3 to 5 parts by weight, more preferably from 0.3 to 4 parts by weight, yet more preferably from 0.3 to 3 parts by weight, still more preferably from 0.3 to 2 parts by weight, particularly preferably from 0.3 to 1 part by weight, and most preferably 1 part by weight, of (B) being mixed into (A) and (D).

Catalyst (D) serves as a hydrosilylation catalyst for the addition reaction between the aliphatically unsaturated hydrocarbon radicals of the diorganopolysiloxanes (A) and the silicon-bonded hydrogen atoms of the organohydropolysiloxanes (B). The literature describes numerous suitable hydrosilylation catalysts. In principle, it is possible to use any of the prior-art hydrosilylation catalysts used in addition-crosslinking silicone rubber compositions.

The hydrosilylation catalyst (D) can comprise metals and their compounds, examples being platinum, rhodium, palladium, ruthenium and iridium, preferably platinum. The metals may optionally be attached to fine-particle support materials, such as activated charcoal, or to metal oxides such as aluminum oxide or silicon dioxide.

It is preferable to use platinum and platinum compounds. Particular preference is given to platinum compounds which are soluble in polyorganosiloxanes. Examples of soluble platinum compounds that can be used are the platinum-olefin complexes of the formulae (PtCl₂.olefin)₂ and H(PtCl₃.olefin), preference being given to alkenes having from 2 to 8 carbon atoms, e.g. ethylene, propylene, isomers of butene and of octene, or cycloalkenes having from 5 to 7 carbon atoms, e.g. cyclopentene, cyclohexene and cycloheptene. Other soluble platinum catalysts are the platinum-cyclopropane complex of the formula (PtCl₂C₃H₆)₂, the reaction products of hexachloroplatinic acid with alcohols, with ethers, and with aldehydes, and mixtures of the same, or the reaction product of hexachloroplatinic acid with methylvinylcyclotetrasiloxane in the presence of sodium bicarbonate in ethanolic solution. Platinum catalysts having phosphorus ligands, sulfur ligands, or amine ligands can also be used, e.g. (Ph₃P)₂PtCl₂. Particular preference is given to complexes of platinum with vinylsiloxanes, such as sym-divinyltetramethyldisiloxane, particular preference being given to the 1,3-divinyl-1,1,3,3-tetramethyldisiloxane Pt complex.

The amount of the hydrosilylation catalyst (D) depends on the desired crosslinking rate and on economic factors. The usual amount used per 100 parts by weight of diorganopolysiloxanes (A) is preferably from 1×10⁻⁸ to 5×10⁻² part by weight, in particular from 1×10⁻⁶ to 1×10⁻² part by weight of platinum catalysts, calculated as platinum metal. The inventive compositions comprise amounts of platinum catalyst (D) such that the resultant platinum content is preferably from 0.05 to 500 ppm by weight (part by weight per million parts by weight), more preferably from 0.5 to 100 ppm by weight, and in particular, from 1 to 50 ppm by weight, based in each case on the total weight of composition).

Platinum catalysts selected from the group consisting of compounds of the formula

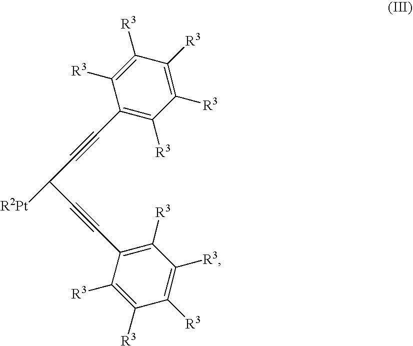

and/or of oligomeric or polymeric compounds composed of structural units of the general formula

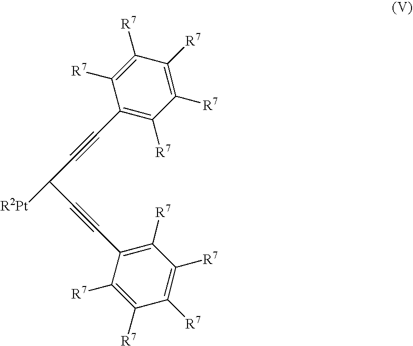

and, if appropriate, structural units of the general formula

R⁹ᵣSiO_{(4-r)/2} (VI),

where
R² is an optionally substituted diene which is bonded to platinum via at least one π-bond and which is an unbranched or a branched chain having from 4 to 18 carbon atoms or is a cyclic ring having from 6 to 28 carbon atoms,
R³ can be identical or different, and is a hydrogen atom, halogen atom, —SiR⁴₃, —OR⁶ or monovalent, optionally substituted hydrocarbon radicals having from 1 to 24 carbon atoms, with the proviso that in the compounds of the formula (III) at least one radical R³ is —SiR⁴₃,
R⁴ can be identical or different, and is hydrogen, a halogen atom, —OR⁶ or a monovalent, optionally substituted hydrocarbon radical having from 1 to 24 carbon atoms,
R⁶ can be identical or different, and is a hydrogen atom, —SiR⁴₃, or a monovalent, optionally substituted hydrocarbon radical having from 1 to 20 carbon atoms,
R⁷ can be identical or different, and is a hydrogen atom, a halogen atom, SiR⁴₃, —SiR⁴₍₃₋ₜ₎[R⁸SiR⁹ₛO_{(3-s)/2}]ₜ, —OR⁶ or monovalent, optionally substituted hydrocarbon radicals having from 1 to 24 carbon atoms, with the proviso that in formula (V) at least one radical R⁷ is —SiR⁴₍₃₋ₜ₎[R⁸SiR⁹ₛO_{(3-s)/2}]ₜ,
R⁸ can be identical or different, and is oxygen or a divalent, optionally substituted hydrocarbon radicals having from 1 to 24 carbon atoms, which may have bonding by way of an oxygen atom to the silicon,
R⁹ can be identical or different, and is hydrogen or an organic radical,
r is 0, 1, 2 or 3,
s is 0, 1, 2 or 3, and
t is 1, 2 or 3.

If R² is a substituted diene or if the radicals R³, R⁴, R⁵, R⁶, R⁷, and R⁸ are substituted hydrocarbon radicals, preferred substituents are halogen atoms, such as F, Cl, Br, and I, cyano radicals, —NR⁶₂, heteroatoms, such as O, S, N, and P, and also —OR⁶ groups, where R⁶ is defined as above.

The platinum catalyst (D) used according to the invention is preferably a bis(alkynyl)(1,5-cyclooctadiene)platinum complex, a bis(alkynyl)(bicyclo[2.2.1]hepta-2,5-diene)platinum complex, a bis(alkynyl)(1,5-dimethyl-1,5-cyclooctadiene)platinum complex, or a bis(alkynyl)(1,6-dimethyl-1,5-cyclooctadiene)platinum complex.

Complexes of platinum with vinylsiloxanes are particularly preferred, e.g. sym-divinyltetramethyldisiloxane, and very particular preference is given to the 1,3-divinyl-1,1,3,3-tetramethyldisiloxane Pt complex.

The amount of the platinum catalyst (D) used depends on the desired crosslinking rate and on the respective end use, and also on economic factors. The inventive compositions comprise amounts of platinum catalyst (D) such that the resultant platinum content is preferably from 0.05 to 500 ppm by weight (part by weight per million parts by weight), more preferably from 0.5 to 100 ppm by weight, and in particular from 1 to 50 ppm by weight, based in each case on the total weight of composition.

For the purposes of the present invention, the term organopolysiloxanes is intended to encompass not only polymeric and oligomeric siloxanes, but also dimeric siloxanes.

The composition used in the inventive process can involve single-component organopolysiloxane compositions or else two component organopolysiloxane compositions. In the latter case, the two components of the inventive compositions can comprise any of the constituents in any desired combination, generally with the proviso that one component cannot simultaneously comprise siloxanes having an aliphatic multiple bond, siloxanes having Si-bonded hydrogen, and catalyst, i.e. in essence cannot simultaneously comprise the constituents (A), (B), and (D) or, respectively, (C) and (D). Inventive compositions can also preferably be termed single-component compositions.

The compounds (A) and (B) used in the inventive compositions are selected in a known manner in such a way as to permit crosslinking. By way of example, therefore, compound (A) contains at least two aliphatically unsaturated radicals, and siloxane (B) contains at least three Si-bonded hydrogen atoms, or compound (A) contains at least three aliphatically unsaturated radicals, and siloxane (B) contains at least two Si-bonded hydrogen atoms, or else instead of compound (A) and (B), siloxane (C) is used which has aliphatically unsaturated radicals and Si-bonded hydrogen atoms in the abovementioned ratios.

The compound (A) used according to the invention can also be silicon-free unsaturated organic compound, preferably one having at least two aliphatically unsaturated groups, or organosilicon compounds preferably having at least two aliphatically unsaturated groups. Examples of organic compounds which can be used as compound (A) in the inventive compositions are 1,3,5-trivinylcyclohexane, 2,3-dimethyl-1,3-butadiene, 7-methyl-3-methylene-1,6-octadiene, 2-methyl-1,3-butadiene, 1,5-hexadiene, 1,7-octadiene, 4,7-methylene-4,7,8,9-tetrahydroindene, methylcyclopentadiene, 5-vinyl-2-norbornene, bicyclo[2.2.1]hepta-2,5-diene, 1,3-diisopropenylbenzene, polybutadiene containing vinyl groups, 1,4-divinylcyclohexane, 1,3,5-triallylbenzene, 1,3,5-trivinylbenzene, 1,2,4-trivinylcyclohexane, 1,3,5-triisopropenylbenzene, 1,4-divinylbenzene, 3-methyl-1,5-heptadiene, 3-phenyl-1,5-hexadiene, 3-vinyl-1,5-hexadiene and 4,5-dimethyl-4,5-diethyl-1,7-octadiene, N,N′-methylenebis(acrylamide), 1,1,1-tris(hydroxymethyl)propane triacrylate, 1,1,1 tris(hydroxymethyl)propane trimethacrylate, tripropylene glycol diacrylate, diallyl ether, diallylamine, diallyl carbonate, N,N′ diallylurea, triallylamine, tris(2-methylallyl)amine, 2,4,6-triallyloxy-1,3,5-triazine, triallyl-s-triazine-2,4,6(1H, 3H, 5H)trione, diallyl malonate, polyethylene glycol diacrylate, polyethylene glycol dimethacrylate and poly(propylene glycol) methacrylate.

However, the novel silicone compositions preferably comprise, as constituent (A), an aliphatically unsaturated organosilicon compound, and use may be made of any aliphatically unsaturated organosilicon compounds useful in addition-crosslinking compositions, and also, for example, silicone block copolymers having urea segments, silicone block polymers having amide segments, imide segments, ester-amide segments, polystyrene segments, silarylene segments, carborane segments, and/or silicone graft copolymers with ether groups.

The organosilicon compound (A) which has SiC-bonded radicals with aliphatic carbon-carbon multiple bonds preferably comprises linear or branched organopolysiloxanes composed of units of the formula

RₐR¹_{b}SiO_{(4-a-b)/2} (I)

where

### R are identical or different and are organic radicals free from aliphatic carbon-carbon multiple bonds,

### R¹ are identical or different and are monovalent, unsubstituted or substituted, SiC-bonded hydrocarbon radicals having an aliphatic carbon-carbon multiple bond,

a is 0, 1, 2 or 3, and
b is 0, 1 or 2,
with the proviso that the sum of a and b is less than or equal to 3 and on average at least 2 radicals R¹ are present in each molecule.

Radicals R may be monovalent radicals or radicals with a valency of two or more, where the radicals with a valency of two or more, such as bivalent, trivalent and tetravalent radicals then bond a number of siloxy units of the formula (I) to one another, for example, two, three or four siloxy units.

R includes the monovalent radicals F, Cl, Br, —OR⁶, —CN, —SCN, —NCO and SiC-bonded, unsubstituted or substituted hydrocarbon radicals, which may be interrupted by oxygen atoms or by the group —C(O)—, or also bivalent radicals Si-bonded on both sides as in formula (I).

If the radicals R are SiC-bonded, substituted hydrocarbon radicals, preferred substituents are halogen atoms, phosphorus-containing radicals, cyano radicals, —OR⁶, —NR⁶—, —NR⁶₂, —NR⁶—C(O)—NR⁶₂, —C(O)—NR⁶₂, —C(O)—R⁶, —C(O)OR⁶, —SO²-Ph and —C₆F₅, in which R⁶ is as defined above and Ph is the phenyl radical.

Examples of radicals R are alkyl radicals such as the methyl, ethyl, n-propyl, isopropyl, n-butyl, isobutyl, tert-butyl, n-pentyl, isopentyl, neopentyl and tert-pentyl radicals, hexyl radicals such as the n-hexyl radical, heptyl radicals such as the n-heptyl radical, octyl radicals such as the n-octyl radical and isooctyl radicals such as the 2,2,4-trimethylpentyl radical, nonyl radicals such as the n-nonyl radical, decyl radicals such as n-decyl radical, dodecyl radicals such as the n-dodecyl radical, and octadecyl radicals such as the n-octadecyl radical; cycloalkyl radicals such as cyclopentyl, cyclohexyl, cycloheptyl and methylcyclohexyl radicals; aryl radicals such as the phenyl, naphthyl, anthryl and phenanthryl radicals; alkaryl radicals, such as o-, m- and p-tolyl radicals, xylyl radicals and ethylphenyl radicals; and aralkyl radicals such as the benzyl radical and the α- and β-phenylethyl radicals.

Examples of substituted radicals R are haloalkyl radicals such as the 3,3,3-trifluoro-n-propyl radical, the 2,2,2,2′,2′,2′-hexafluoroisopropyl radical, and the heptafluoroisopropyl radical; haloaryl radicals such as the o-, m- and p-chlorophenyl radicals, —(CH₂)ₙ—N(R⁶)C(O)NR⁶₂, —(CH₂)ₙ—C(O)NR⁶₂, —(CH₂)ₙ—C(O)R⁶, —(CH₂)ₙ—C(O)OR⁶—(CH₂)ₙ—C(O)NR⁶₂—(CH₂)ₙ—C(O)—(CH₂)ₘ—C(O)CH₃, —(CH₂)ₙ—NR⁶—(CH₂)ₘ—NR⁶₂, —(CH₂)ₙ—O—CO—R⁶, —(CH₂)ₙ—O—(CH₂)ₘ—CH₂)ₘ—CH(OH)—CH₂OH, —(CH₂)ₙ—(OCH₂CH₂)ₘ—OR⁶, —(CH₂)ₙ—SO₂-Ph and —(CH₂)ₙ—O—C₆F₅, where R⁶ has one of the meanings given above, and n and m are identical or different integers from 0 to 10 and Ph is the phenyl radical.

Examples of R as bivalent radicals Si-bonded on both sides as in formula (I) are those derived from the monovalent examples given above for radical R in that an additional bond substitutes a hydrogen atom. Examples of radicals of this type are —(CH₂)ₙ—, —CH(CH₃)—, —C(CH₃)₂—, —CH(CH₃)—CH₂—, —C₆H₄—, —CH(Ph)-CH₂—, —C(CF₃)₂—, —(CH₂)ₙ—C₆H₄—(CH₂)ₙ—, —(CH₂)ₙ—C₆H₄—C₆H₄—(CH₂)ₙ—, —(CH₂O)ₘ—, —(CH₂CH₂O)ₘ— and —(CH₂)ₙ—Oₓ—C₆H₄—SO₂—C₆H₄—Oₓ—(CH₂)ₙ, where x is 0 or 1, m and n are as defined above, and Ph is the phenyl radical.

The radical R is preferably a monovalent, SiC-bonded, unsubstituted or substituted hydrocarbon radical having from 1 to 18 carbon atoms and free from aliphatic carbon-carbon multiple bonds, more preferably a monovalent, SiC bonded hydrocarbon radical having from 1 to 6 carbon atoms and free from aliphatic carbon-carbon multiple bonds, in particular the methyl or phenyl radical.

Radicals R¹ may be any desired groups amenable to addition reaction (hydrosilylation) with an SiH-functional compound. If the radicals R¹ are SiC-bonded, substituted hydrocarbon radicals, preferred substituents are halogen atoms, cyano radicals and —OR⁶, where R⁶ is as defined above. R¹ are preferably alkenyl or alkynyl groups having from 2 to 16 carbon atoms such as vinyl, allyl, methallyl, 1-propenyl, 5-hexenyl, ethynyl, butadienyl, hexadienyl, cyclopentenyl, cyclopentadienyl, cyclohexenyl, vinylcyclohexylethyl, divinylcyclohexylethyl, norbornenyl, vinylphenyl or styryl radicals, most preferably vinyl, allyl and hexenyl radicals.

The molecular weight of constituent (A) may vary within wide limits, for example from 10² to 10⁶ g/mol. Constituent (A) may, therefore, for example, be a relatively low-molecular-weight alkenyl-functional oligosiloxane, such as 1,2-divinyltetramethyldisiloxane, but may also be a highly polymerized polydimethylsiloxane having Si-bonded vinyl groups positioned along the chain or terminally, e.g. having a molar mass of 10⁵ g/mol (number average determined by NMR). The structure of the molecules forming the constituent (A) is also not critical. In particular, the structure of a higher-molecular-weight, i.e. oligomeric or polymeric, siloxane may be linear, cyclic, branched or even resin-like or network-like. Linear and cyclic polysiloxanes are preferably composed of units of the formula R₃SiO_{1/2}, R¹R₂SiO_{1/2}, R¹RSiO_{2/2} and R₂SiO_{2/2}, where R and R¹ are as defined above. Branched and network-like polysiloxanes additionally contain trifunctional and/or tetrafunctional units, where preference is given to those of the formulae RSiO_{3/2}, R¹SiO_{3/2} and SiO_{4/2}. It is, of course, also possible to use mixtures of different siloxanes meeting the criteria for the constituent (A).

The component (A) preferably comprises vinyl-functional, essentially linear, polydiorganosiloxanes with a viscosity of from 0.01 to 500,000 Pa·s, more preferably from 0.1 to 100,000 Pa·s, in each case at 25° C.

The organosilicon compound (B) used may be any hydrogen-functional organosilicon compound useful in addition-crosslinkable compositions. The organopolysiloxanes (B) used which have Si-bonded hydrogen atoms preferably comprise linear, cyclic or branched organopolysiloxanes containing units of the formula

R_{c}H_{d}SiO_{(4-c-d)/2} (II)

where

### R can be identical or different and are as defined above,

c is 0, 1, 2 or 3, and
d is 0, 1 or 2,
with the proviso that the sum of c and d is less than or equal to 3 and on average at least two Si-bonded hydrogen atoms are present in each molecule.

The organopolysiloxane (B) preferably contains Si-bonded hydrogen in the range from 0.04 to 1.7 percent by weight, based on the total weight of the organopolysiloxane (B). The molecular weight of constituent (B) may likewise vary within wide limits, for example from 10² to 10⁶ g/mol. Constituent (B) may, therefore, for example, be a relatively low-molecular-weight SiH-functional oligosiloxane, such as tetramethyldisiloxane, but may also be a highly polymeric polydimethylsiloxane having SiH groups positioned along the chain or terminally, or a silicone resin having SiH groups. The structure of the molecules forming the constituent (B) is also freely selectable. In particular, the structure of a relatively high-molecular-weight, i.e. oligomeric or polymeric, SiH-containing siloxane may be linear, cyclic, branched or else resin-like or network-like. Linear and cyclic polysiloxanes are preferably composed of units of the formula R₃SiO_{1/2}, HR₂SiO_{1/2}, HRSiO_{2/2} and R₂SiO_{2/2}, where R is as defined above. Branched and network-like polysiloxanes additionally contain trifunctional and/or tetrafunctional units, preferably those of the formulae RSiO_{3/2}, HSiO_{3/2} and SiO_{4/2}. It is, of course, also possible to use mixtures of different siloxanes meeting the criteria for the constituent (B). In particular, the molecules forming the constituent (B) may, in addition to the obligatory SiH groups, optionally contain aliphatically unsaturated groups. Particular preference is given to the use of low-molecular-weight SiH-functional compounds, such as tetrakis(dimethylsiloxy)silane and tetramethylcyclotetrasiloxane, and also relatively high-molecular-weight SiH-containing siloxanes, such as poly(hydromethyl)siloxane and poly(dimethylhydromethyl)siloxane with viscosity of from 10 to 10,000 mPa·s at 25° C., or analogous SiH-containing compounds in which some of the methyl groups have been replaced by 3,3,3-trifluoropropyl or phenyl groups.

The amount of constituent (B) present in the novel crosslinkable silicone compositions is preferably such that the molar ratio of SiH groups to aliphatically unsaturated groups is from 0.1 to 20, more preferably from 1.0 to 5.0.

Components (A) and (B) used according to the invention are commercially available products or can be prepared by familiar chemical processes.

Bis(alkynyl)(η-olefin)platinum compounds and processes for their preparation are known to the person skilled in the art. In this context, reference may be made, for example, to J. CHEM. SOC., Dalton Trans. (1986), 1987-92 and ORGANOMETALLICS (1992), 11, 2873-2883. The inventive platinum catalysts (D) can be prepared by analogous steps of synthesis and of purification.

The platinum catalyst (D) employed is preferably a bis(alkynyl)(1,5-cyclooctadiene)platinum complex, a bis(alkynyl)(bicyclo[2.2.1]hepta-2,5-diene)platinum complex, a bis(alkynyl)(1,5-dimethyl-1,5-cyclooctadiene)platinum complex, or a bis(alkynyl)(1,6-dimethyl-1,5-cyclooctadiene)platinum complex, or mixture thereof.

The platinum catalyst (D) may also be a complex of platinum with vinylsiloxanes, e.g. sym-divinyltetramethyldisiloxane, with particular preference given to the 1,3-divinyl-1,1,3,3-tetramethyldisiloxane Pt complex.

The amount of the platinum catalyst (D) used depends on the desired crosslinking rate and on the respective end use, and also on economic factors. The inventive compositions comprise amounts of platinum catalyst (D) such that the resultant platinum content is preferably from 0.05 to 500 ppm by weight, more preferably from 0.5 to 100 ppm by weight, and in particular from 1 to 50 ppm by weight, based in each case on the total weight of composition.

The inventive curable compositions can also comprise, other than components (A) to (D), any further substances which are useful when preparing addition-crosslinkable compositions.

Examples of reinforcing fillers which can be used as component (E) in the inventive compositions are fumed or precipitated silicas whose BET surface areas are at least 50 m²/g, and also carbon blacks and activated charcoals, e.g. furnace black and acetylene black, preference being given here to fumed and precipitated silicas whose BET surface areas are at least 50 m²/g.

The silica fillers mentioned can have hydrophilic character or can have been hydrophobicized by known processes. A hydrophobicizer is required when mixing to incorporate hydrophilic fillers. The content of active reinforcing filler (E) in the inventive crosslinkable composition is preferably in the range from 0 to 70% by weight, more preferably from 0 to 50% by weight.

The inventive silicone rubber composition can optionally comprise, as constituent (F), further fillers in a proportion of up to 70% by weight, preferably from 0.0001 to 40% by weight. These additives can, for example, be inert fillers, resin-like polyorganosiloxanes which differ from the siloxanes (A), (B), and (C), dispersing agents, solvents, adhesion promoters, pigments, dyes, plasticizers, organic polymers, heat stabilizers, etc. Among these are additives such as powdered quartz, diatomaceous earth, clays, chalk, lithopones, carbon blacks, graphite, metal oxides, metal carbonates, metal sulfates, metal salts of carboxylic acids, metal dusts, fibers, such as glass fibers, synthetic fibers, plastics powders, dyes, pigments, etc.

Additives (G) which serve for controlled adjustment of processing time, initiation temperature, and crosslinking rate of the inventive compositions can also be present. These inhibitors and stabilizers are very well known in the field of addition-crosslinking compositions. Examples of familiar inhibitors are acetylenic alcohols, such as 1-ethynyl-1-cyclohexanol, 2-methyl-3-butyn-2-ol, and 3,5-dimethyl-1-hexyn-3-ol, 3-methyl-1-dodecyn-3-ol, polymethylvinyl-cyclosiloxanes, such as 1,3,5,7-tetravinyltetramethyltetracyclosiloxane, low-molecular-weight silicone oils having methylvinylSiO_{2/2} groups and/or R₂ vinylSiO_{1/2} end groups, e.g. divinyltetramethyldisiloxane, tetravinyldimethyldisiloxane, trialkyl cyanurates, alkyl maleates, such as diallyl maleate, dimethyl maleate, and diethyl maleate, alkyl fumarates, such as diallyl fumarate and diethyl fumarate, organic hydroperoxides, such as cumene hydroperoxide, tert-butyl hydroperoxide, and pinane hydroperoxide, organic peroxides, organic sulfoxides, organic amines, diamines, and amides, phosphanes, and phosphites, nitriles, triazoles, diaziridines, and oximes. The action of these inhibitor additives (G) depends on their chemical structure, and must therefore be determined individually. The inhibitor content of the inventive compositions is preferably from 0 to 50,000 ppm, particularly preferably from 20 to 2000 ppm, in particular from 100 to 1000 ppm.

The inventive organopolysiloxane compositions can, if required, be dissolved, dispersed, suspended, or emulsified in liquids. The inventive compositions can, in particular as a function of viscosity of the constituents, and also filler content, be of low viscosity and pourable, have paste-like consistency, be pulverulent, or else be high-viscosity conformable compositions, as is known to be the case with the compositions frequently termed by persons skilled in the art RTV-1, RTV-2, LSR, and HTV. In particular, if the inventive compositions have high viscosity, they can be prepared in the form of pellets. Each individual pellet here can comprise all of the components, or components D and B used according to the invention can have been incorporated separately in different pellets. Equally, the entire spectrum is covered with regard to the elastomeric properties of the crosslinked inventive silicone compositions, beginning with extremely soft silicone gels and passing by way of rubbery materials through to highly crosslinked silicones with glassy properties.

The inventive organopolysiloxane compositions can be prepared by known processes, for example via uniform mixing of the individual components. The mixing sequence is as desired, but preference is given to the uniform mixing of the mixture composed of (A) and (B), and if appropriate (E), (F), and (G) to give a composition, charged to a container. The platinum catalyst (D) used according to the invention can be added subsequently in the form of solid substance, in dispersion, or in the form of solution, dissolved in a suitable solvent, or in the form of what is known as a masterbatch. The mixing takes place immediately prior to processing, using a static or dynamic mixer, as described below. The catalyst (D) is preferably added by pumping by means of an additive pump.

Each of the components (A) to (G) used according to the invention can be a single type of this component, or else a mixture composed of at least two different types of this component.

The inventive compositions crosslinkable via an addition reaction of Si-bonded hydrogen to an aliphatic multiple bond can be crosslinked under conditions identical with those used for the compositions known hitherto and crosslinkable via a hydrosilylation reaction. The temperatures are preferably from 100 to 220° C., more preferably from 130 to 190° C., and the pressure is preferably from 900 to 1100 hPa. However, higher or lower temperatures and pressures can also be used.

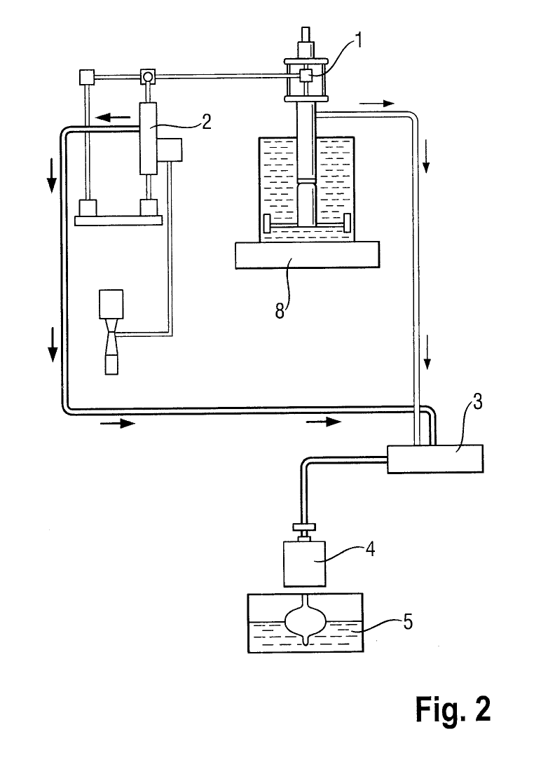

The inventive process is described in FIG. 2: 100 parts of the major component are pumped from the measurement apparatus (1) and from 1 to 2 parts of the Pt catalyst are pumped from the measurement apparatus (2) to the mixer (3). The mixed reactive material then passes onward for processing, preferably into an injection-molding machine. It is then preferably injected into a heated cold-runner mold (4, 5) and vulcanized to give a molding.

A surprising finding of the invention was that the cycle time for a pacifier of unit weight 5 g is now only half of that of a conventional liquid silicone in a mixing ratio of 1:1 to 9:1. Additional advantages result from the fact that the main component can now comprise constituents which are incompatible with the Pt catalyst. By virtue of the short contact time between the Pt catalyst and the substances incompatible therewith, its activity is not impaired prior to processing.

Furthermore, variation of the amount of the Pt catalyst can be used to adjust the vulcanization rate to the respective processing requirements. This gives the possibility of savings which cannot be achieved with 9:1 or 1:1 systems, because in the case of the latter the mixing ratio has to be accurately maintained. A reduction in catalyst content prior to shutdown of the plant for repair purposes moreover lengthens the time that can elapse before production restarts.

In a preferred method for the inventive process for preparation of curable organopolysiloxane compositions, a soft (low-viscosity) composition is pumped from one drum and a “harder” (high-viscosity) composition is pumped from another drum in any desired mixing ratio to the static mixer, and (D) and/or (B) are fed by way of a pump unit.

### INVENTIVE EXAMPLES

Base composition: 70% of polydimethylsiloxane (PDMS) having terminal vinyl groups, whose viscosity (at room temperature) is 20,000 mPa·s, and 30% of silazane-hydrophobicized silica whose specific surface area is 300 m²/g are mixed homogeneously.

### Example 1

0.3 part of trimethylsilanol, 1.75 parts of Si—H crosslinking agent having 0.46% of silicon-bonded hydrogen and viscosity of 100 mPa·s, and 0.08 part of ethynylcyclohexanol are added to 100 parts of the base composition.

This mixture is charged to 20 l drums.

The drums are clamped into the pumping unit of an ENGEL LSR machine. A preparation of the platinum catalyst (1,3-divinyl-1,1,3,3-tetramethyldisiloxane Pt complex in silicone oil with viscosity of 500 mPa·s; Pt content 0.1%) is charged to the color line (usually used only for feeding of color masterbatches) of the machine, and pumped at a level of 1.5% per 100% of mixture to the static mixer.

In the static mixer, 100 parts of mixture and 1.5 parts of platinum catalyst are mixed with one another, and homogenized, and then passed under pressure into the injection cylinder of the injection-molding machine. The injection cycle then follows. The injection molding produced was a drinking nipple, using an EMDE mold. Cycle time is 10 s.

### Example 2

0.3 part of trimethylsilanol, 1.5 parts of a preparation of the platinum catalyst (Example 1) and 0.08 part of ethynylcyclohexanol are added to 100 parts of base composition.

This mixture is charged to 20 l drums.

The drums are clamped into the pumping unit of an ENGEL LSR machine. The Si—H crosslinking agent (having 0.46% of H functions and viscosity of 100 mPa·s) is charged to the color line (usually used only for feeding of color masterbatches) of the machine, and pumped at a level of 1.75% per 100% of mixture to the static mixer.

In the static mixer, 100 parts of mixture and 1.75 parts of Si—H crosslinking agent are mixed with one another, and homogenized, and then passed under pressure into the injection cylinder of the injection-molding machine. The injection cycle then follows. The injection molding produced was a drinking nipple, using an EMDE mold. Cycle time is 20 s.

Mechanical properties can be varied via +−10% variation of crosslinking agent content. Cycle time can also be varied via addition of a crosslinking agent having high Si—H content.

### Comparative Example

The A component comprises 100 parts of base composition, 3 parts of Pt catalyst, and 0.3 part of trimethylsilanol.

The B component comprises 100 parts of parent composition, 3.5 parts of Si—H crosslinking agent, and 0.16 part of ethynylcyclohexanol.

The A component and the B component of the same LSR are processed traditionally on the same plant in a mixing ratio of 1:1. The cycle time is 20 s. No variations are possible with respect to cycle time and/or mechanical properties.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A process for the preparation of curable organopolysiloxane compositions from an addition-crosslinkable mixture comprising
(A) compound(s) which bear radicals containing aliphatic carbon-carbon multiple bonds,
(B) organopolysiloxane(s) containing Si-bonded hydrogen atoms,
(D) at least one hydrosilylation catalyst,
the process comprising first admixing 100 parts by weight of (A) and (B) or (A) and (D) to form a curable mixture and then feeding the curable mixture into a mixer of a plastics-processing machine, and separately feeding to the mixer from 0.3 to 5 parts by weight of (D) into the curable mixture of (A) and (B), or separately feeding to the mixer from 0.3 to 5 parts by weight of (B) into the curable mixture of (A) and (D).

2. The process of claim 1, wherein at least one catalyst is selected from the group consisting of 1,3-divinyl-1,1,3,3-tetramethyldisiloxane Pt complexes, bis(alkynyl)(1,5-cyclooctadiene)-platinum complexes, bis(alkynyl)(bicyclo[2.2.1]hepta-2,5-diene)platinum complexes, bis(alkynyl)(1,5-dimethyl-1,5-cyclooctadiene)platinum complexes, and bis(alkynyl)(1,6-dimethyl-1,5-cyclooctadiene)platinum complexes.

3. The process of claim 1, wherein (D) and (B) are fed to the mixer by way of a pump.

4. The process of claim 2, wherein (D) and (B) are fed to the mixer by way of a pump.

5. The process of claim 1, wherein the plastics-processing machine is an injection-molding machine.

6. The process of claim 1, wherein in addition to components (A) and (B) or in lieu of components (A) and (B), an organopolysiloxane (C) is employed which contains both aliphatic carbon-carbon double bonds and silicon-bonded hydrogen.
